(19) United States
(12) Patent Application Publication
(10) Pub. No.: US 2014/0344181 A1
(43) Pub. Date: Nov. 20, 2014

(54) CONSTRUCTION TRADE BUILDING INFORMATION MANAGEMENT SYSTEM, SOFTWARE AND METHOD

(71) Applicant: Tiffany Hosey Brown, Oakton, VA (US)

(72) Inventor: Tiffany Hosey Brown, Oakton, VA (US)

(73) Assignee: Tiffany Hosey Brown, Oakton, VA (US)

(21) Appl. No.: 13/897,350

(22) Filed: May 17, 2013

Related U.S. Application Data
(63) Continuation-in-part of application No. 13/988,218, filed on May 17, 2013.

(51) Int. Cl. G06Q 50/08; G06Q 10/10

(52) U.S. Cl. CPC G06Q 50/08; G06Q 10/10
USPC 705/342

(57) ABSTRACT

A construction information system for managing construction project in real-time, comprising a server, database in communication with a computer and a remote client having a software application enabling communication between the server and client.

### CROSS REFERENCE TO RELATED APPLICATIONS

This a continuation-in-part application of application Ser. No. 13/988,218, filed May 17, 2013, which is a National Stage application of PCT International Application No. PCT/US2012/022421, filed Jan. 24, 2012, which claims priority from provisional application No. 61/461,950, filed Jan. 25, 2011, the contents of all are incorporated herein by reference.

### FIELD OF THE INVENTION

The present invention relates to a computer-based construction-specific information management system, software and method and asset management system. More particularly, the present invention relates a construction-specific information management system, software application and method, configured to interface with architecture software, and enable web-based remote access of integrated real-time construction information, thereby enabling a user to track and aggregate comprehensive building information throughout a construction process.

### BACKGROUND

Purpose-built for building information modeling (BIM), Autodesk® Revit® Architecture, Aveva building design software and any design software used for complex structures such as submarines, aircraft carriers, airplanes, helicopters, nuclear facilities, etc., which helps architects and designers capture and analyze early concepts, and maintain designs through documentation and construction. Present inventory tracking applications and systems configured to work in conjunction with the BIM and other architectural design software architecture are deficient in enabling real-time information to be remotely transmitted to and from the construction site. Software applications, such as COBIE, are adequate for their intended purposes, however, construction-specific information that is uploaded through the COBIE software application cannot be remotely accessed and updated in real-time from the construction site by personnel at the site.

### SUMMARY OF THE INVENTION

The real-time ability to track construction progress, and keep track of inventory during all phases of construction, can be vital in maintaining project efficiency. The present invention provides a system and software application that enables web-based remote access to pre-loaded construction information in real-time. The present invention enables the creation of a 3D schematic skeletal rendering of a structure that is transparent at the beginning of a project and becomes colored in real-time when the “completed” date and time stamp button is entered, which indicates components of a structure have been constructed or installed. The present invention enables onsite personnel to access pre-loaded information, such as plans, or drawing specifications, remotely from the field and capture completion of construction progress in real time by photographing, with a date and time stamp, the physical condition of the material/equipment installed or constructed, which records the precise moment of construction completion. The photograph can be uploaded onto the attributes page for the room location in the structure where the material/equipment was installed or constructed. The present invention not only provides real-time information to on-site personnel, but also enables construction stakeholders (i.e., owners, architects, engineers, project managers, construction trades, construction executives) to manage the project with real-time information about every stage of the construction progress. The present invention also provides a time clock for each item installed or constructed by field crew which starts to run at the time of user (field crew member) login, stops when the “completed” time and date stamped button is entered and restarted when another attributes page for the structure is accessed by the user.

Further, the information system in conjunction with the software application, in accordance with the present invention, tracks inventory from the point of delivery at the construction site, and, archives information and data related to materials and equipment, such that if and when changes to architectural drawings occur, unused materials and equipment can be used as replacement inventory in the future. Further, the system collects and archives, in real time, all information utilized to construct the building for use during construction and post-construction for facilities management and maintenance.

This summary is provided to introduce concepts in a simplified form that are further described in the detailed description of the invention. This summary is not intended to identify key or essential inventive concepts of the claimed subject matter, nor is it intended for determining the scope of the claimed subject matter. The components of the invention are an information system process for managing a specified construction project in real-time, comprising a server, database in communication with a computer and a remote client having a software application enabling communication between the server and the client. The system process comprises preloading architectural drawing data and a first construction information set onto a server and relational database. The next steps comprises remotely inputting a second construction project installation information set from the specified construction project and comparing the second project installation information set to architectural drawing data and the first project installation information set to identify construction information discrepancies and construction progress.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein, in which:

FIGS. 1-22 illustrate the functionality of the software application and information system, in accordance with the present invention such that:

FIG. 1 illustrates a system block diagram showing the functional diagram of the information system and software application, in accordance with the present invention;

FIG. 2 is a flow chart diagram illustrating the process of the information system;

FIG. 3 illustrates an example of a screen shot of the data entry interface of the software application;

FIG. 4 is a diagram illustrating an example of the data set relationships in the system database;

FIG. 5 illustrates an example of a screen shot of the products portal of the software application;

FIG. 6 illustrates a screen display of user data input screen;

FIG. 7 illustrates an example of a screen shot of a reports portal of the software application;

FIG. 8 is an Attribute value screen display;

FIG. 9 is an example of a Bulletin Index or Change Order;

FIGS. 10A and 10B illustrate a functional overview of the system and software application, in accordance with the present invention;

FIG. 11 illustrates a flow diagram of the management system preconstruction process;

FIG. 12 illustrates a flow diagram of the inventory control standard operating procedure;

FIG. 13 illustrates a flow diagram of the construction by Field Crews Process;

FIG. 14 illustrates a flow diagram of the changes in Architectural Drawings process;

FIG. 15 illustrates a flow diagram of the system reporting process;

FIG. 16 illustrates a flow diagram of the archival inventory tracking process;

FIG. 17 illustrates a flow diagram of the turnover standard operating procedure process;

FIG. 18 illustrates an example of a products portal screen display;

FIG. 19 illustrates a flow diagram of the 3D parts capture function;

FIG. 20A illustrates a schematic diagram of a room to be displayed on a screen display.

FIG. 20B illustrates a screen display of the punch list automation function;

FIG. 21 illustrates a flow diagram of the punch list automation function; and

FIG. 22 illustrates a flow diagram of the accounting and budgeting function.

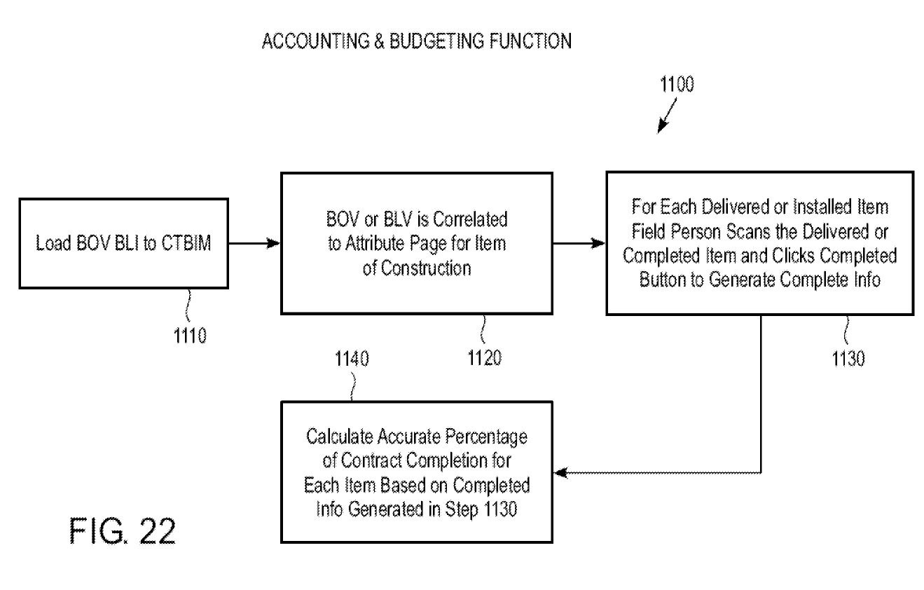

### DETAILED DESCRIPTION OF THE INVENTION

Particular embodiments of the present invention will now be described in greater detail with reference to the figures.

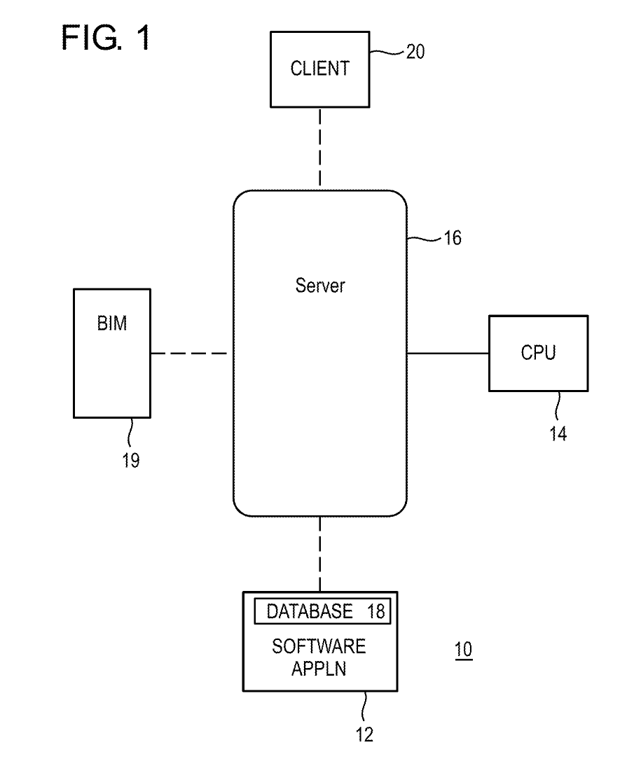

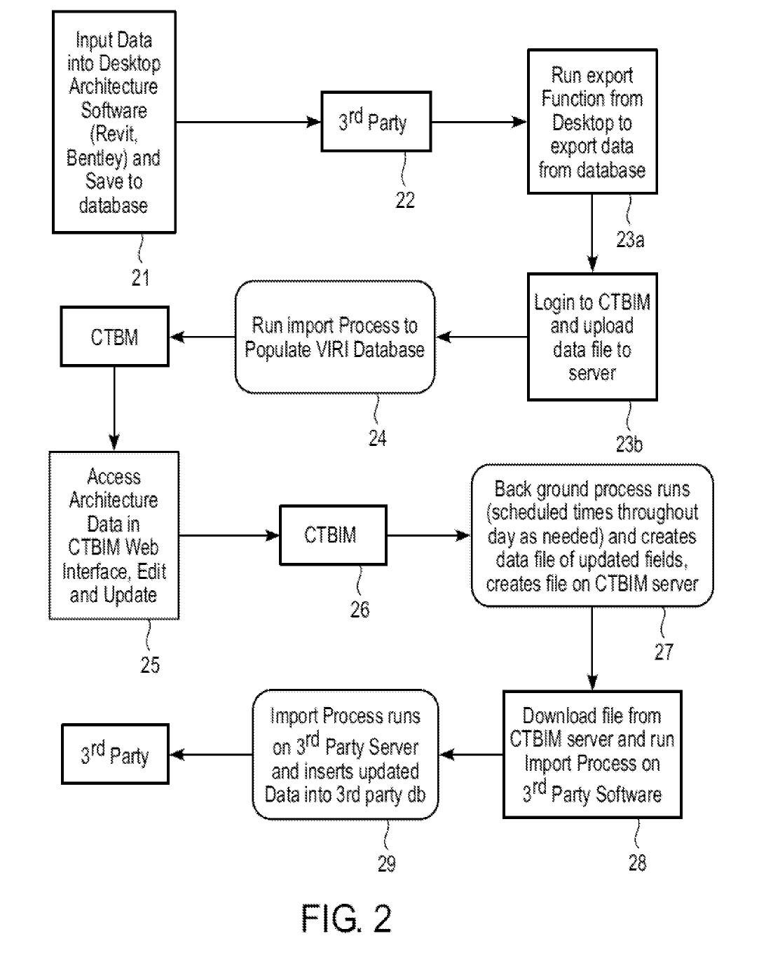

Referring now to FIG. 1, there is shown a functional block diagram of one example of the construction data information system 10, in accordance with the present invention. The system 10 comprises a software application 12, one or more computers 14 comprising a screen display, a server 16, a database 18, a BIM 19, and one or more clients 20, in communication with the server 16 and a database 18 processed by the software application 12. The database 18 can be any of several products currently available and generally known to those skilled in the art. However, in the preferred embodiment, it is contemplated that the database is a relational database, such as a SQL Database Server or similar type.

In the present invention, the client 20 can be a PDA, computer, IPAD, smart phone, or other wireless, or mobile device, generally known in the art. It is contemplated that the components, CPU 14 and client 20 of the system 10, have a web-based browser application providing a viewable portal cooperatively with the software application 12. Accordingly, the system 10 uses a wireless communication system generally known in the art, to communicate between the client 20 and the server 16.

In the present embodiment the system 10 or software application 12 can individually or jointly comprises a relational database 18 and server 16. The software application 12 is web-based, enabling construction-specific project data and information to be accessed locally by the computer 14, and remotely via the client 20. In the present embodiment, the software application 12 comprises Microsoft.net C+ programming language, which is generally compatible with most common BIM software protocols used by architecture software providers, such as BENTLEY, REVIT or Aveva, among others. A further description of the Microsoft.net C+ language is provided via reference at www.microsoft.com. Notably, it is contemplated that the software application 12 can comprise other programming languages, such as Hypertext Preprocessor “php,” Java, or Linux, for example, without departing from the scope of the present invention.

As stated, the software application 12 uses computer language compatible with BIM software program architecture, such as RIVET, BENTLEY or other construction software applications, generally known in the art. The software application 12 formats pre-loaded construction data and organizes the data into pre-configured data sets, enabling the information to be displayed and manipulated using a web-based browser application, provided by the computer 14 and/or client 20.

The construction-specific information stored in the database 18 is retrievable via data packets which are wirelessly streamed from the server 16 and accessed remotely by the client 20 via a web-based browser. In another embodiment, the information is stored locally on the client 20 and accessible using the software application 12. As information is input into the software application 12 in real-time at the host computer 14 and remotely from the client 20 the software application 12 compares the input information to the pre-loaded data stored in the database 18 to identify any discrepancies which will be discussed later.

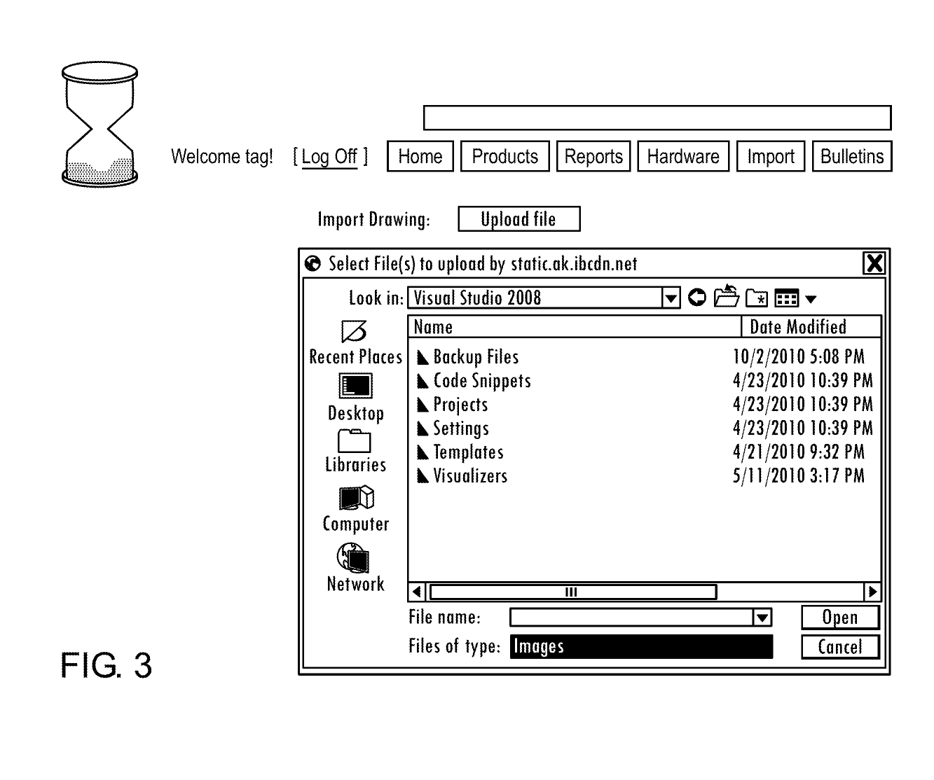

Referring now to FIG. 2, there is shown a flow chart diagram illustrating the process and/or function of the system 10 cooperatively with the software application 12. As shown, data files Step 21 that contain architectural plans, materials, building specifications, etc. are initially stored on third party architecture software application 22, such as Revit or Bentley. Notably, in another embodiment, this data can also be stored locally on a separate database in communication with the architecture software and the system 10. Using the software application 12, building personnel runs the export function of the third party architecture software Step 23a, login to the software application 12 Step 23b and uploads or exports Step 24 the construction-specific information to the server of the system 10, and database 18. This information can be architectural drawings, building specifications, floor plans, materials, and any other sort of information desired. Notably, this information is formatted for compatibility with the third party architecture software protocols.

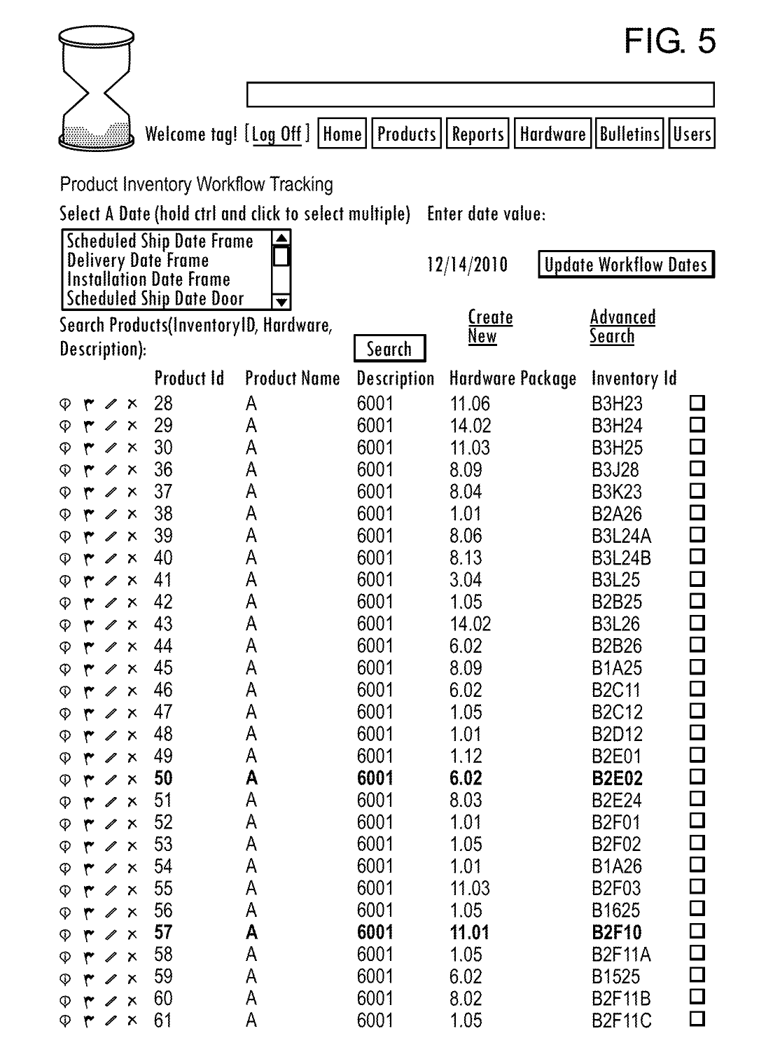

In the present embodiment, construction-specific information and/or data is provided in a generally text format. However, it is contemplated that the construction-specific information can be in other formats, such as XML, without departing from the scope of the present information. Once the construction-specific data file is loaded into the database 18. The software application 12 and database 18 organize the data into data sets in accordance with the data's attributes Step 25. One example of relational database 18, data fields and attributes is illustrated in FIG. 4, and will be discussed later in this application.

Once the data is communicated to the system 10, the software application 12 uses a pre-programmed filter to process the data. In this embodiment, the user pre-selects the type of project/job that the data is being used for and accordingly, the data is arranged in the database 18 according to the selected project data set attributes stored in database 18. The software application 12 processes the data and arranges the data into a series of pre-customized data fields. For example, in the present embodiment, the customized data fields are preconfigured for door installation, air conditioning system, plumbing, electrical system, phone systems, flooring, bathroom accessories, and generally all construction trades on a complex construction project. Accordingly, each data field has attributes relating to the construction-specific data for each trade on a construction project. Notably it is contemplated that other forms of construction-specific data or other templates pertaining to other kinds of construction projects, i.e. nuclear facilities, aircraft carriers, airplanes, helicopters, submarines, among other things, are pre-loaded into the software application 12 and database 18, without departing from the scope of the present invention. This data is viewable by the user by a web-based portal Step 26. The software application 12, for example running in the background, automatically compares information pertaining to the data attributes loaded in the database 18 from the third party architecture server, to data uploaded locally via the CPU or remotely via the client 20, and creates data files of updated fields and files in the software application 12 Step 27. In comparing preloaded data to present data, discrepancies in information is detected by the software application 12 and reported real-time to users remotely and locally connected. The process of Step 27 can be scheduled to run at preset times throughout the day and/or run as needed. Also, at such times the various data files, including those that have been updated, stored in the database 18 of the software application 12 are downloaded so as to be imported in the third party architecture software 22 Step 28. Thereafter, the downloaded files, including those that have been updated, from the database 18 of the software application 12 are imported into the third party architecture software 22 Step 29.

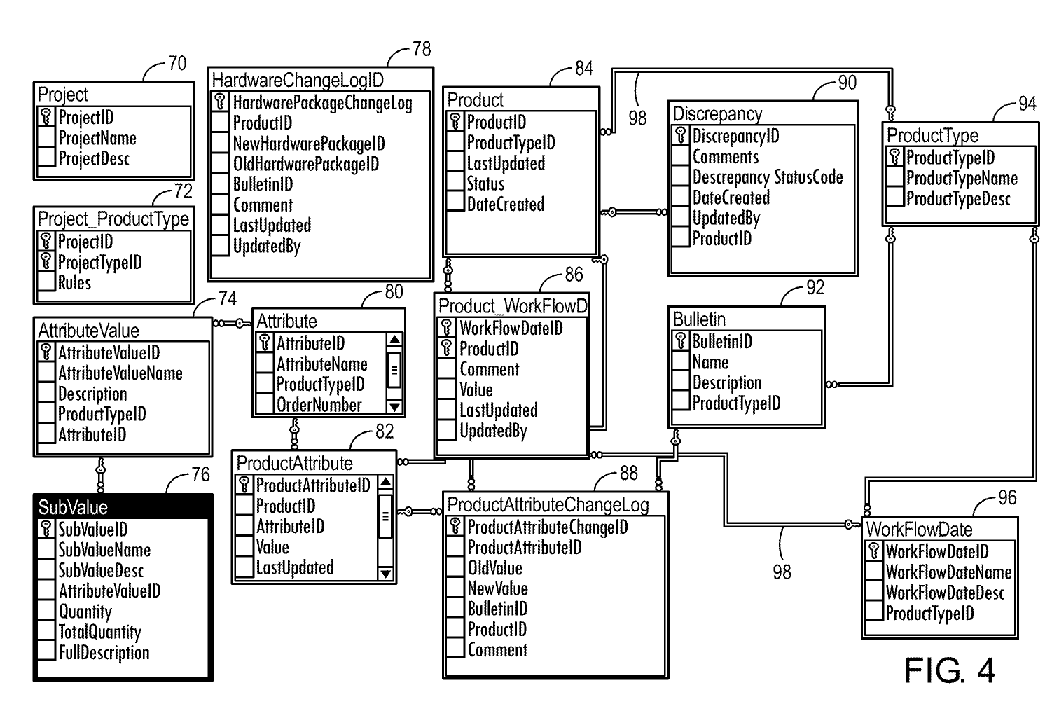

FIG. 3, illustrates a display screen generated by the software application 12. As shown, using the software application 12, the user uploads construction-specific information stored in a designated data file. After the construction-specific information is uploaded into the database 18, the software application 12 arranges and compares the data to the pre-configured software application's data fields and information is sorted according to attributes.

FIG. 4 is a diagram illustrating an example of the relational database 18 organization, in accordance with the present invention. As shown, the database 18 comprises a series of data sets (70-96) to organize construction-specific-information. In this example, the database 18 has data set specific subheadings to organize construction specific data for a Door Installation Project. Notably, as stated, it is contemplated that the database 18 is configurable to provide data sets for numerous different types of construction related projects, without departing from the scope of the present invention. It is further contemplated that the software application 12 can detect the number of data fields required by querying the uploaded data, and based on such information generates “n” number of fields to arrange the data, without departing from the scope of the present invention.

As shown in this Door Installation Project example, the data sets provided are labeled Project 70, ProjectProduct Type 72, Attribute Value 74, Subvalue 76, Hardware Change Logic 78, Attribute 80, Product Attribute 82, Product 84, Product Work_FlowD 86, ProductAttributeChangeLog 88, Discrepancy 90, Bulletin 92, ProductType 94, and WorkFlowDate 96. Each data set has a series of sub-headings representing data set attributes that are used to categorize the construction-specific data in the database 18. For example, Project Data Set 70 stores information related to Project ID, Project Name, and Project Description. In another example, Bulletin Data Set 92 has a data set containing a Bulletin ID, Name, Description and Product Type ID used to store data related to a specific Bulletin and information related to that Bulletin, including a Description and a Product Type ID. A list of all of the data set attributes in this example is further provided in List of Data Set Attributes below.

FIG. 4 also illustrates the shared relationship between data sets with one or more connecting lines 98. For example, data entered by a user regarding a Bulletin is assigned the aforementioned attributes for a Bulletin data set 92 and shared with the Product Type Data Set 94 and the Product Attribute Change Log Data Set 88. Without specifically explaining every connecting line, further examples of shared relationships of the data set is this example are illustrated in FIG. 4. It should be noted that these connecting lines defining various relationships can be set in any number of ways depending on the project and its purpose.

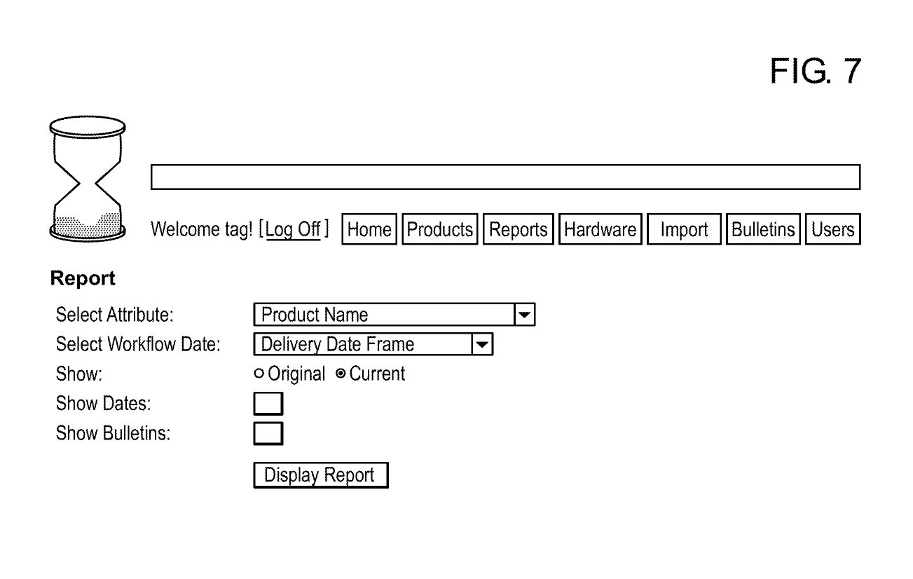

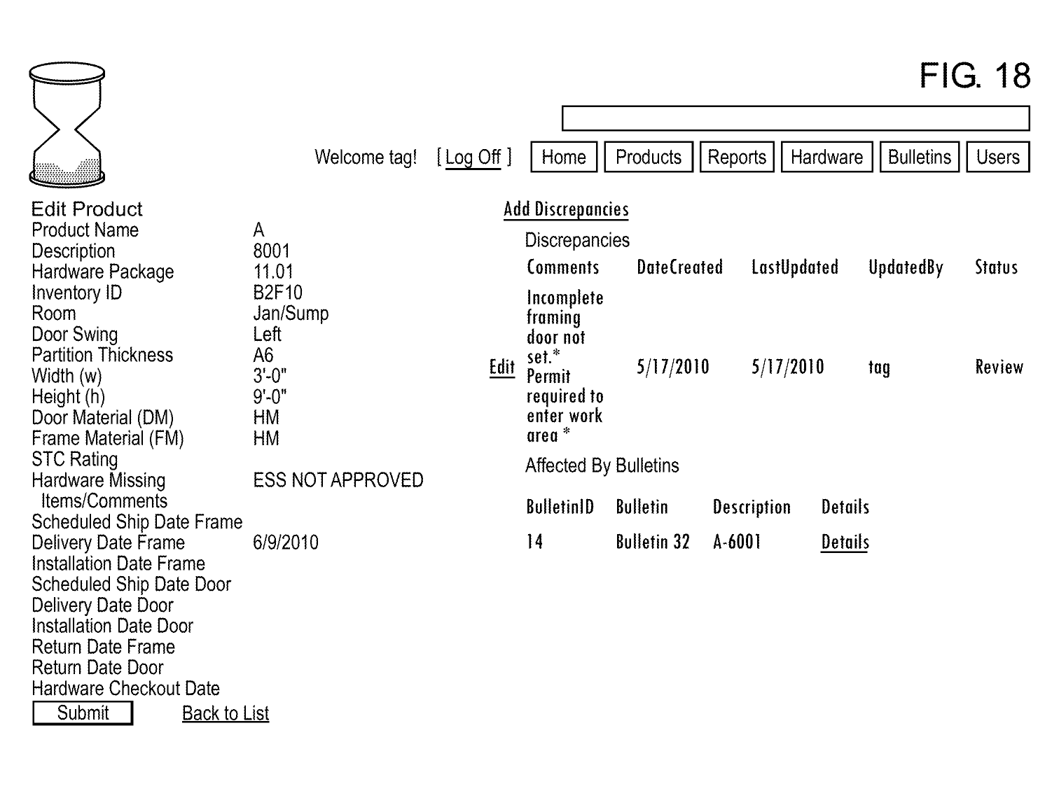

FIG. 6, illustrates an example of the user's screen display input portal of the viewable data fields by the software application 12, for a construction project. As shown, in the present example, viewable data fields are provided for: 1) the location of the door and frame; 2) the kind of material the door and frame is made of; 3) the dimension of the door and frame; 4) the partition size of the walls adjacent to the door and frame; 5) swing of the door and frame; 6) the ship date of the door and frame; 7) delivery date of the door and frame; 8) the installation date of the door and frame; 9) the sound rating, if any, of the door and frame; 10) the hardware package assigned to the door and frame; and, 11) the architectural drawings depicting the door and frame. This portal enables a user to update information. As information is input through this user's portal, it is processed, compared to pre-loaded data and can be modified within the database 18 by a user using this portal. This information is further displayable on a detailed products portal in FIG. 18, which will be discussed further in this application.

Once the data is uploaded, the software application 12 organizes the data in the database 18 in accordance with the pre-configured data sets relative to the selected project. The software application 12 provides a series of user friendly portals enabling a user to view data stored in the database and specifically data sets. The portals are configurable in accordance with the desired construction project. The software application 12 provides cross referencing of information between data sets. The relational database indicated in FIG. 4 illustrates the shared information between the data sets.

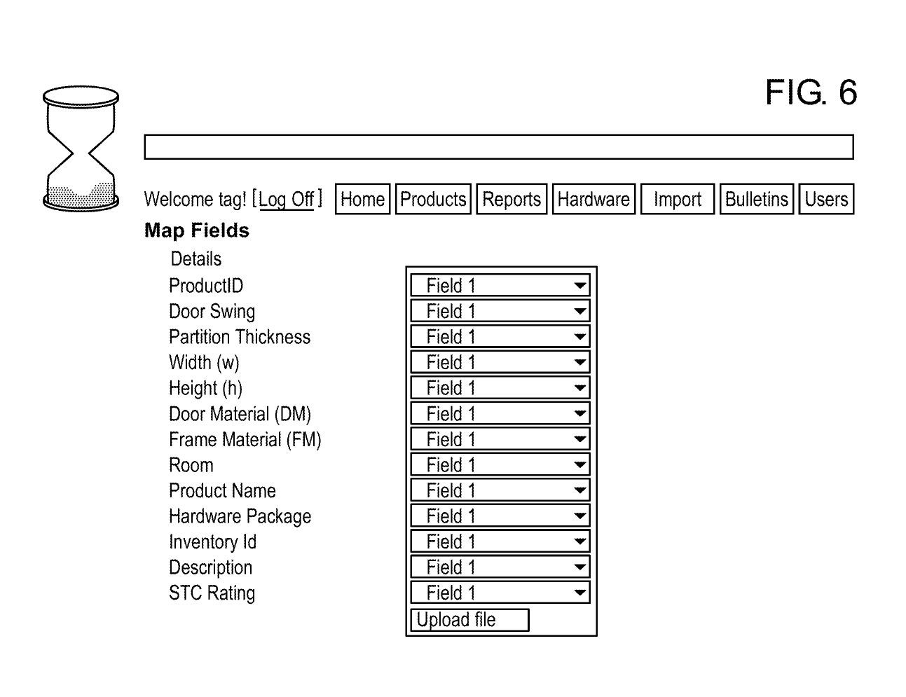

As shown in FIG. 5, the product inventory tracking portal provides a web-based portal for viewing data and connectivity to more detailed related data. For example, pre loaded data pertaining to all of the door openings in a desired building in organized spreadsheet format, with attribute subheadings Product ID, Product Name, Description, Hardware, Package and Inventory. A user can select an icon (pencil in this case) to obtain more related information, which will then open a products portal (FIG. 18) which displays more details relating to the selected attribute.

For example, in a door installation project, door openings and locations can be pre-assigned a unique identifier, or inventory ID in the architectural database, such as B3H23, wherein B3 indicates location, such as, the second floor and H23 indicates the room number on that floor. Detailed information regarding inventory ID B3H23 is saved in a database.

The user selects the identifier, such as, B2F10 for openings. Information pertaining to that identifier is retrieved and displayed in a Products Portal, illustrated in FIG. 18. As shown, related attributes related to the identifier are listed for that particular opening. In the event construction-specific information is entered by a user that does not comply with information stored in the database 18, the software application 12, detects the discrepancy and flags attribute. As previously mentioned, the software application 12 detects discrepancies in data. In this case, a door opening identifier is highlighted on the product inventory tracking portal, whenever a discrepancy in information exists pertaining to that identifier.

The software application 12 in real-time automatically compares information pertaining to the data attributes loaded in the database 18 from data stored in the third party architecture server (preloaded data) to data uploaded locally via the CPU or remotely via the client 20 upon detection by the field crew. The field crew can input information of the discrepancy into the client which is then transmitted to the software application 12 via the server 16, send an email noting the discrepancy to a pre-designated person such as a system administrator who may then enter information regarding the discrepancy to the software application 12 via the server 16. In comparing preloaded data to present data, discrepancies between said data is detected by the software application 12 and automatically flagged, thereby alerting a user of the discrepancy. In the present embodiment, a discrepancy/comment/RFI is noted and indicated via highlight, or made bold, on the products inventory workflow tracking display screen, FIG. 5.

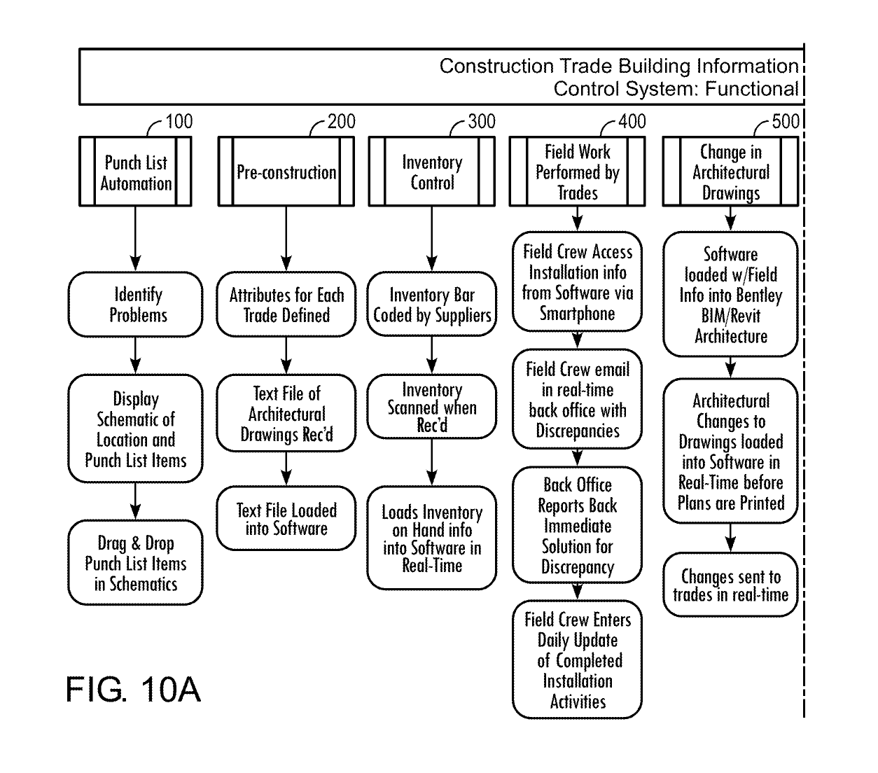

The products user portal provides detailed information of a selected attribute. As shown in FIG. 18, the products portal provides information pertaining to a selected identifier “B2F10”. The products portal provides a field that enables comments or discrepancies to manually be enterer by a user remotely or locally. Further, whenever there is a discrepancy between what the architectural data indicate and what field personnel see in real time at the construction site, that information can be immediately communicated to a home office or pre-designated person via the application to resolve the inconsistency between what is at the construction site and the conditions depicted in the architectural drawings. The products portal further indicates related “Bulletins” or change orders, which references information stored and displayable in the Bulletins portal, in FIG. 9.

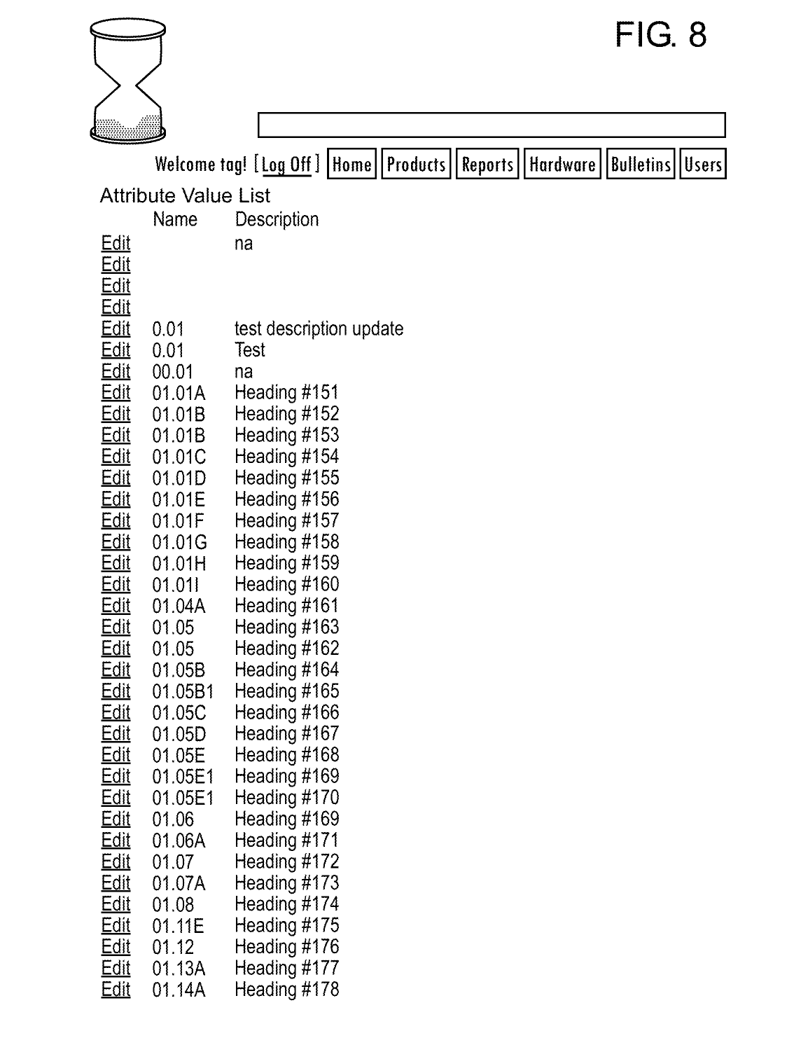

Referring now to FIG. 7, there is shown an example of a reports portal screen display 80 provided by the software application 12. The reports portal 80 enables a user to search the construction-specific data and generate a report based on a desired attribute. For example, a user can activate a search that filters the construction-specific information to provide a list of material delivered or installed on a desired date. In other examples, reports can be produced to identify the doors and frames that have been installed in particular rooms or, by floors, by dates, by installer, or a specific number overall. It is contemplated that reports can be generated based on any desired pre-loaded attribute. Once a report is generated, information can be filtered to produce reports that can be exported to an Excel spreadsheet and printed.

The software application 12 provides an email feature that enables field personnel to send an email to the home office or a pre-designated person immediately when a discrepancy between the data is detected. Notably, this feature enables the user to obtain instant explanation for the discrepancy if one is available from the home office or pre-designated person. If not, the issue will be highlighted, or made bold, in the system 10 on products inventory page until an answer has been provided and documented in the system 10.

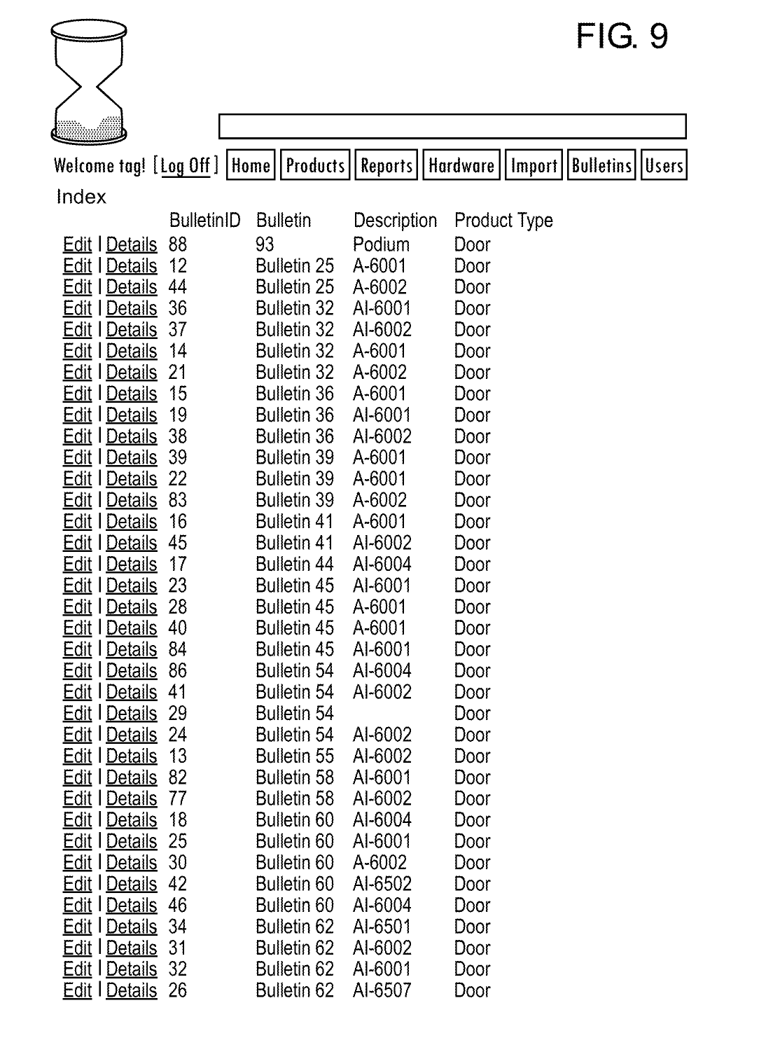

Further, as shown in FIG. 9, a user can see all changes to the architectural drawings (“Bulletins”) that impact some aspect of that particular opening in a “Bulletin index” page. For example, if a user changes the door material or dimensions, that information is entered on the Bulletins or change order page and it automatically updates the changed information on the “attributes value list” page of that particular opening as illustrated in FIG. 8.

On the attributes value list page, a user can select the “Bulletins” tab and then click on a Bulletin affecting the opening, and be linked to the Bulletin's page where they can see what aspects of the attributes for a given opening have been changed. Under the “hardware” tab, all items included in a hardware package are listed in total and the number of each hardware item assigned to each door is listed in a parallel format. For example, the hardware items in the package are listed, the total number of each item is listed, and then the number of each piece of hardware for each opening using that item is listed. New hardware packages can be added on the main “hardware” page. An example of the Hardware page is similar to that illustrated in FIG. 9.

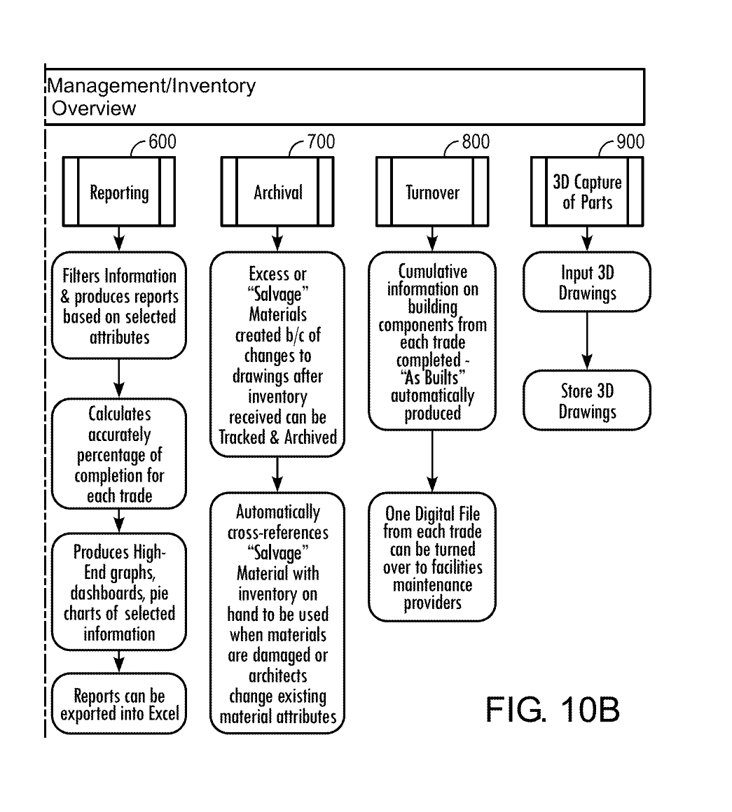

FIGS. 10A and 10B illustrate a schematic representation of the data information system 10 in accordance with the present invention. As shown, there are several functions performed by the information system 10. The information system 10 implements a Construction Trade Building Information Management/Inventory (CTBIM) Control System 100 which controls several functions such as, pre-construction 200, inventory control 300, field work performed by trades 400, changes to Architectural Drawings 500, Reporting 600, Archiving 700, Turnover 800, 3D Capture of Parts 900 and Punch List Automation 1000. The information system 10 in cooperation with the software application 12 enables information to be shared between the server 16, database 18, CPU 14 and remote client 20 to access information stored in the data fields in real time.

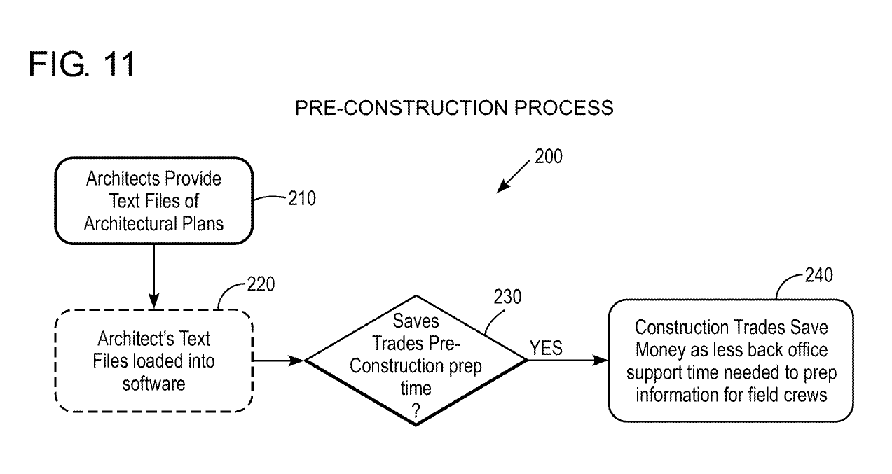

Referring now to FIG. 11 which illustrates a flow diagram of the system 10 using the software application 12 at the pre-construction phase 200. As indicated at step 210 files of the architectural plans are provided, preferably in text format containing data and specifications relating to the materials to be used. The files are loaded into the software application's database 220. Notably, it is contemplated that the information can be loaded into a database compatible and in communication with the software application 12, without departing from the scope of the present invention. Loading the information into the system reduces the need for field crew to carry heavy, voluminous floor/design plans in the field to aid in their construction activities 230. Specifically, the software application 12 enables owners of construction projects, construction trades, and construction stakeholders to realize greater efficiencies, minimized human error, increased profits, reduced risks, better cash flow control and heightened transparency as information is transmitted to field crew in real time, before updated designs plans can be printed 240.

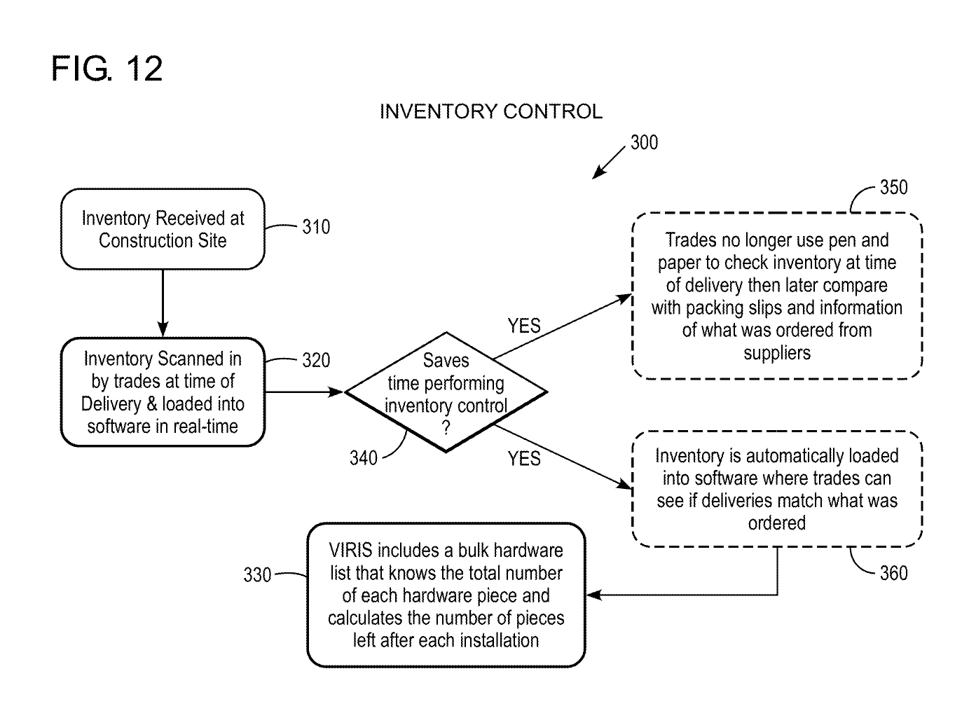

Referring now to FIG. 12, which illustrates the inventory control function 300 operating process and procedures in accordance with the present invention. As illustrated, in step 310 inventory is received at the construction site. In step 320 inventory is scanned by personnel, such as trades, using a mobile client 20 in communication with the software application 12. The client 20 can be a FDA, computer, or mobile in conjunction with bar code technology, generally known to those skilled in the art. By scanning the inventory, the inventory data is loaded into the client 20 and transmitted to the server and database. Using the software application 12, personnel can retrieve information from the database in real-time to confirm an order. In addition the software application 12 has the complete inventory list pre-loaded, and accordingly maintains real time inventory control and status by comparing incoming inventory data provided at step 320 to inventory data stored on the database 18, which in this example is a bulk hardware list. The software application 12, based on the comparing performed in real time can, for example, display to the user a calculation of the number of hardware pieces that may be left after each installation 330. Thus, the software application 12 provides efficiencies so as to save time performing inventory control 340. Specifically, the software application 12 provides efficiencies in that the field crew no longer need to use pen and paper to make notes to check inventory at the time of delivery then later compare packing slips to their note of what was ordered from suppliers 350. Further, the software application 12 provides efficiencies that inventory and updates to the inventory are automatically loaded into the software application 12 which permits trades to view deliveries and match what was ordered to what was received 360.

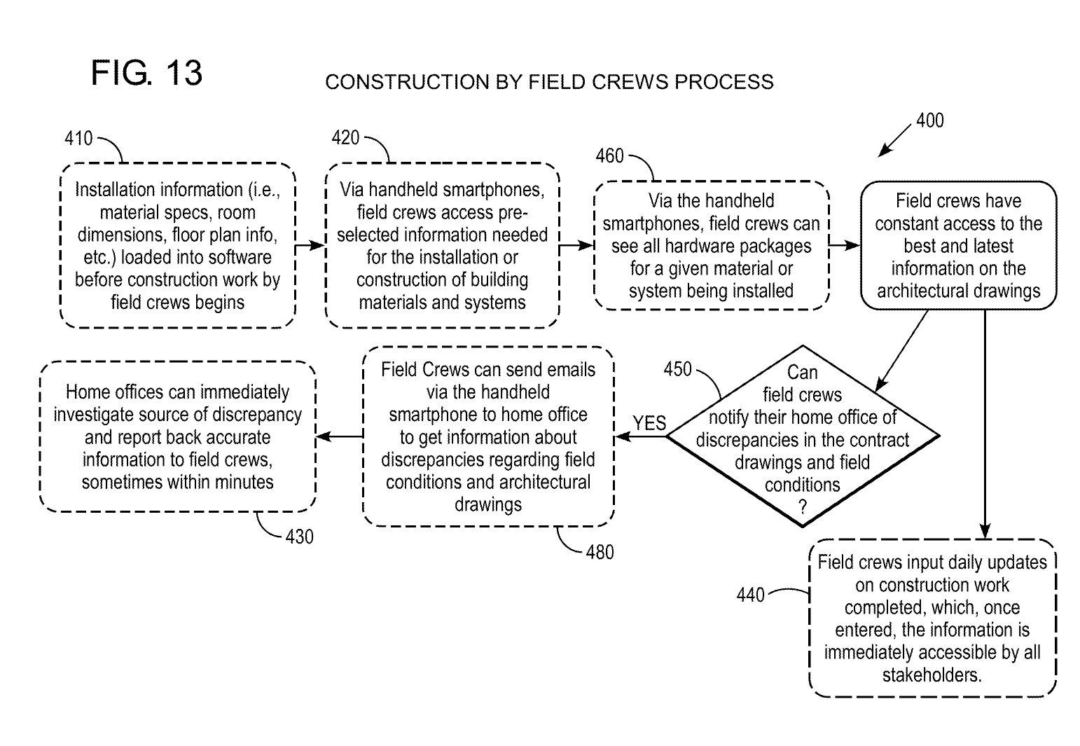

Referring now to FIG. 13, there is shown the document management process 400, in accordance with the present invention. In step 410 installation/construction information (i.e. specifications, room dimensions, floor plans, etc.) is loaded into the application database prior to construction. In step 410, using the software application 12, field personnel can interface with and access and view information stored in the home application database 18, which is viewable using the client 20. Field crew can view all hardware information for a preferred project. Accordingly, field personnel can access the information and in real-time, notify the home office maintaining construction information if a hardware deficiency occurs. If information in the home office database is updated, field personnel can access this information remotely using the software application. In step 420 of the process, field crews input daily updates on construction work completed and this information is transmitted to the server 14 and application 12 and is accessible in real time by office personnel and stakeholders. Thus, according to the present invention home offices can immediately investigate the source of any discrepancy and report back accurate information to field crews, immediately 430. Further, field crews input daily updates on construction work completed, which once entered the information is immediately accessible by all stakeholders 440. Thus, the software application 12 provides efficiencies so that field crews can notify their home office of discrepancies in the contract drawings and field conditions 450. Specifically, the software application 12 provides efficiencies in that via handheld smartphones or tablet computers, field crews can see all hardware packages for a given material or system being installed 460 as such field crews have constant access to the best and latest information on the architectural drawings 470. The software application 12 allows field crews to send emails via the handheld smartphones or tablet computers to the home office to get information about discrepancies regarding field conditions and architectural drawings 480.

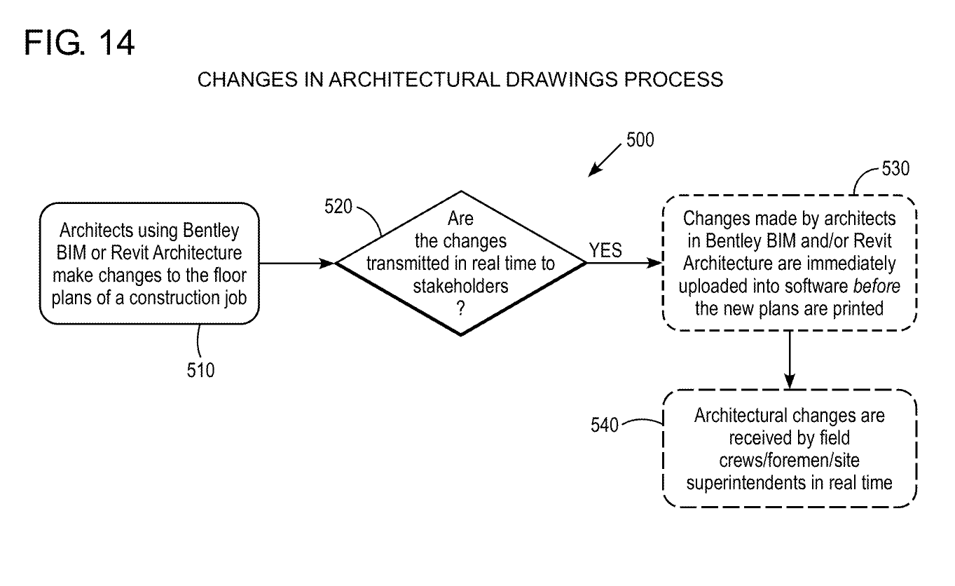

FIG. 14 is a flow diagram 500 illustrating the system 10 process of handling changes to the architectural drawings. As shown in step 510, as personnel such as architects make changes to the construction project, such as floor plan changes, these changes are entered into the database 18 and accessible remotely by field personnel through the client 20, such that these changes can be viewed using the client 20. Thus, the software application 12 provides efficiencies so as to allow for changes to be transmitted in real time to all stakeholders 520. Specifically, the software application 12 provides efficiencies in that changes made by the architects in the design software are immediately uploaded into the software application 12 before the new plans are printed 530. Further, the changes are received by the field crews in real time 540.

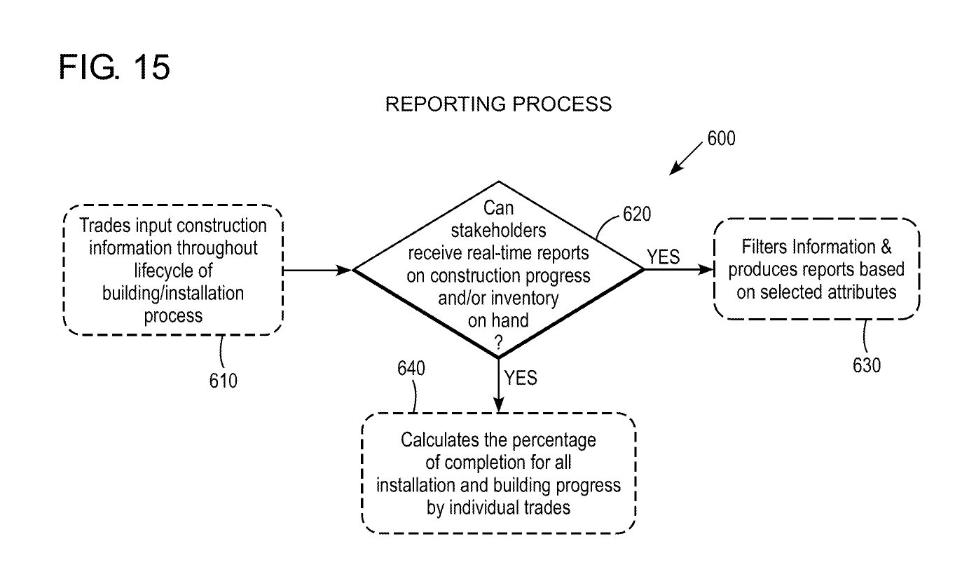

FIG. 15 illustrates the system 10 enabling a construction reporting progress 600. As shown in step 610 as trades input construction information into the client 20, information is transmitted in real-time to the software database 18. Accordingly, the application can generate reports using desired fields. Thus, the software application 12 provides efficiencies so as to allow stakeholders to receive real-time reports on construction progress and/or inventory on hand 620. Specifically, the software application 12 provides efficiencies in that the software application 12 filters information and produces reports based on selected attributes 630. In addition the software application 12, based on the continual inputting and updating of the information, the software application 12 can calculate the percentage of completion for all installation and building progress by individual trades 640. It can also provide precise percentage of completion for construction trades that have elected to have their Schedule of Values of Budgeted Line Items uploaded into the system, which will record percentage of completion whenever field crew enter the construction completed button on the attributes page or scan in inventory items as received as more fully explained below. Accordingly, users of the software application 12 can submit pay applications that can be validated based on real-time construction progress information recorded by trades daily in the software application 12. This function of the application replaces the inexact method of validation, which typically involves an owner's representative walking around a project site and eyeballing structures and inventory, “guessing” on whether the percentage completed claimed by the trades is accurate. On a large, complex construction project, “eyeball” validation can result in unnecessary friction between general contractors and trades, as pay applications are often not approved for amounts that mirror actual construction progress.

In addition to the above the construction reporting progress 600 of the system 10 also has an accounting feature that more accurately captures the percentage of contract completion for each trade utilizing the software on a construction project. Alternatively this accounting feature can be independent of the construction reporting progress 600.

Specifically, according to the accounting features clients can have their individual schedule of values (herein “SOV”) or budgeted line items (herein “BLI”) for each phase of a client's project loaded into the system 10 at the beginning of a project. The SOV or BLI will be tied to the attributes page for each item of construction preloaded into the software. Therefore, whenever a particular item, material or piece of equipment has been delivered on site or completely installed in a structure or constructed on a structure, when a field person scans the delivered item into the system or clicks the “completed” button for having completed construction or installation, that information is logged into the SOV or BLI. The system 10 then calculates an accurate percentage of contract completion for each component or material delivered on site or installed in a structure or constructed on a structure. Since the information of when something has been constructed or installed is captured in real time, the calculation of percentage of contract completion on the SOV or BLI is always available in real time.

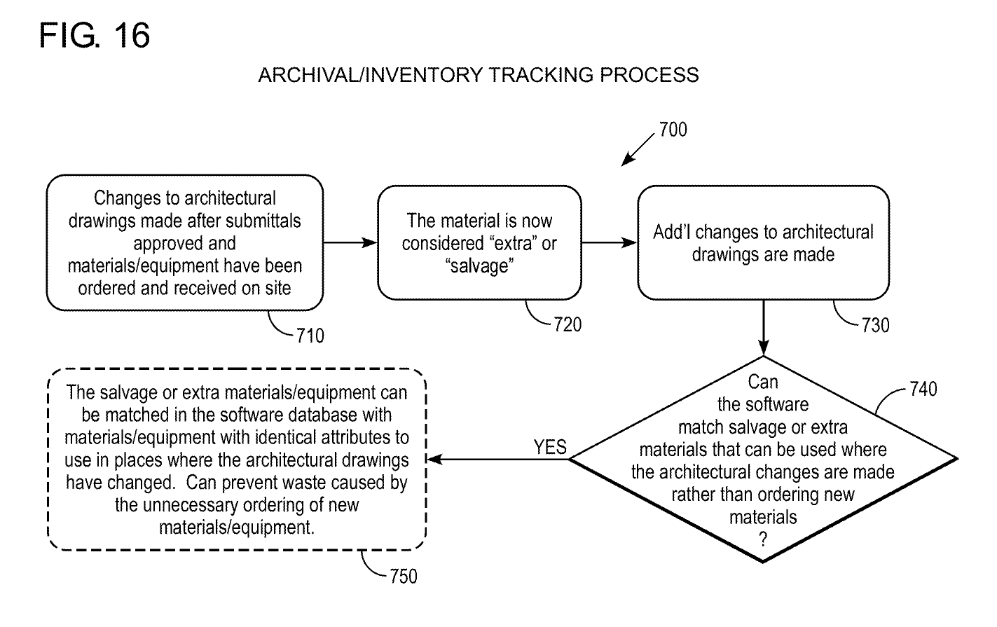

FIG. 16 illustrates a flow diagram of the archiving inventory tracking process 700 of the system 10, in accordance with the present invention. As illustrated in step 710, as any changes to the architectural drawings are made, materials and equipment that are received at the construction site are inventoried and stored in the database 18 such that materials and equipment can be immediately identified as being usable or identified as extra or salvage 720. In the event additional changes are made to the architectural drawings, the software application 12 uses the identifying code stored in the database 18 to identify the materials such that those materials can be used 730. The benefit of this inventorying process is by providing an inventory and query process, the ability to identify items on site will prevent the materials from being reordered. Thus, the software application 12 provides efficiencies so as to match salvage or extra materials that can be used where the architectural changes are made rather than ordering new materials 740. Specifically, the software application 12 provides efficiencies in that the salvage or extra materials or equipment can be matched in the software application 12 with material or equipment with identical attributes to use in places where the architectural drawings have been changed, thereby preventing waste caused by the unnecessary ordering of the materials or equipment 750.

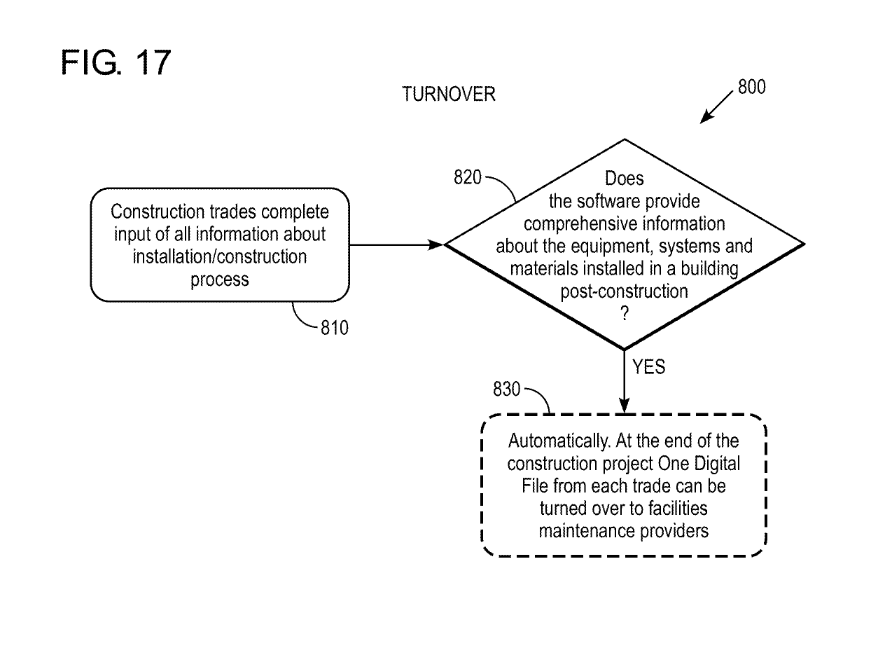

FIG. 17 illustrates a flow diagram of the document management and post construction information at turnover process 800 of the system 10, in accordance with the present invention. As illustrated in step 810, the construction trades complete the input of all information of the installation/construction process, thereby providing a complete set of data and documents of the completed project. Thus, the software application 12 provides efficiencies so as to provide comprehensive information about the equipment, systems and materials installed in a building post construction 820. Specifically, the software application 12 provides efficiencies in that automatically, at the end of the construction project one digital file for each trade can be turned over to facilities maintenance providers 830.

Another embodiment of the present invention is the 3D Parts Capture function 900 which enables clients to archive reusable personal property and enables users to catalog and maintain real-time records of the component parts of inventory.

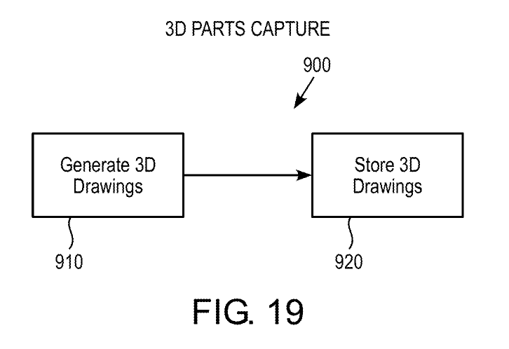

As shown in FIG. 19 the information system 10 implementing the 3D Parts Capture function 900 under control of the CTBIM Control System 100 utilizes third party 3D visualization software to generate universally accepted 3D pdf drawing files from scanned inventory manuals of the parts to be inventoried or from advanced data collection through 3D laser scanning apparatus 910. The 3D pdf drawing files store data concerning the structure and configuration of each part, and data of the corresponding relation of each part relative to other parts such that the data graphically illustrates and describes how the parts form an assembly 920. Each part is also stored in corresponding relation to various information/data identifying the part, the location of the part, and the condition of the part. Specifically the 3D pdf drawings files are stored into customized templates that can be accessed in real-time from any location and device. The 3D pdf drawing files allows users to visualize the assembly and disassembly of the component parts of equipment, materials and/or personal property, or visualize step-by-step maintenance or repair procedures. Clients can easily identify the component parts of materials/equipment or personal property entered into the customized templates. The 3D Parts Capture function 900 is integrated with asset management solution as follows:

Field crew performing installations of equipment or construction of materials can have the assembly manual of the equipment or materials being installed scanned into a CAD file, which is then converted to a 3D pdf drawing file that can display how to assemble, disassemble, perform maintenance and/or repair of the equipment or material being installed or previously installed. Additionally, software can incorporate a template that provides a step by step check-off that requires field crews to check off each step of assembly and/or disassembly as a method of ensuring accurate installation or construction of the equipment or material or accurate compliance with each step of maintenance or repair procedures.

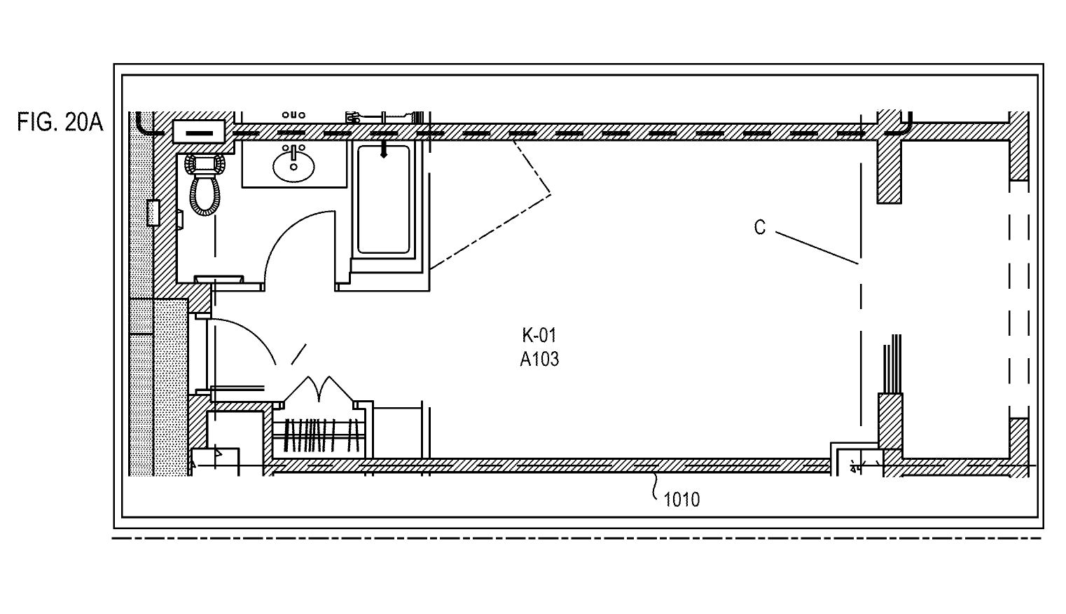

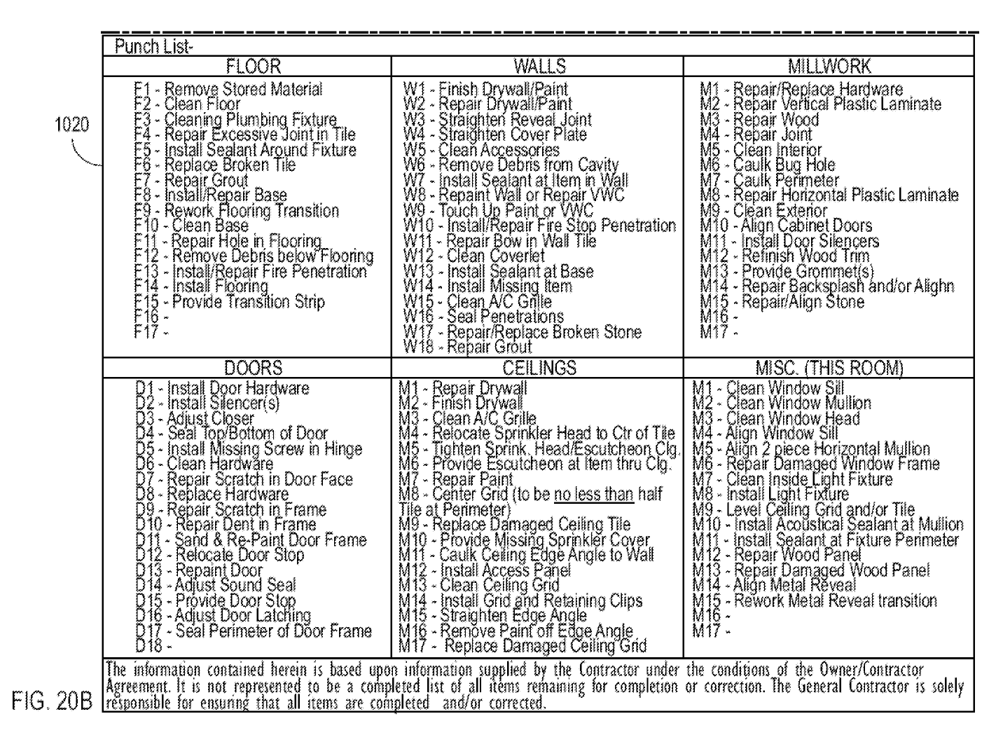

Another embodiment of the present invention is the Punch List Automation function 1000 which is implemented in the smartphone, tablet computer or desktop computer with touchscreen capabilities, by the operation using the touch screen and the drag and drop features of the smartphone. According to the present invention as shown in FIGS. 20A and 20B when implementing the Punch List Automation function 1000 in a schematic 1010 of a room in a building, aircraft carrier, a portion of a ship, a portion of a plane, a portion of some complex structure, and a list of punch list items 1020 below the schematic 1010 of the room are displayed on the display screen of the smartphone.

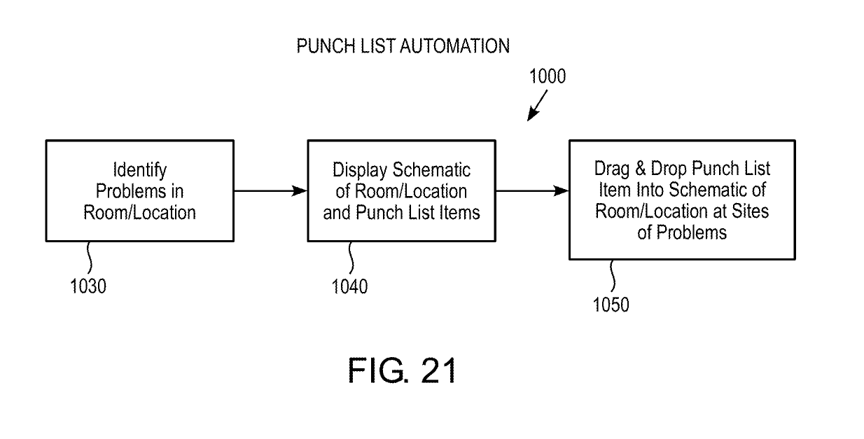

As shown in FIG. 21 the punch list process begins by the party responsible for the initiating and/or conducting the punch list process walking around a room in a structure after all construction work is completed and placing blue tape on the wall where some identified problem appears 1030. The problem could be a deficiency such as scratched paint on the wall, a dent in a door, an electrical outlet that is not working, among many other things. Thereafter, or at the same time as the first walk through, another person, architect, owner's agent, construction manager, or general contractor, among other persons could walk around with a smartphone or tablet computer, pull up the schematic 1010 of the room and the list of punch items 1020, and drag and drop the punch list items 1040 and 1050, which are essentially descriptions of various deficiencies or problems, onto the locations in the schematic 1010 of the room where the deficiencies or problems noted by the architect or general contractor appears. The punch list items, which have been dragged, dropped and pinpointed by an arrow that can be manipulated to precisely point to the deficiency, appear in the locations in the schematic 1010 of the room where the deficiencies or problems noted by the person conducting the punch list inspection and are identified by unique symbols. Each symbol can include an identifier of a specific punch list item (i.e. F5 as shown in FIG. 20B) and can be a different color relative to other items in the schematic 1010 of the room.

### LIST OF DATA SET ATTRIBUTES

### Project Data Set

### Project ID

### Project Name

### Project Description

### Project_Product Type Data Set

### Project ID

### Product TypeID

### Rules

### Attribute Value

### Attribute Value ID

### Attribute ValueName

### Description

### Product TypeID

### Attribute ID

### SubValue

### SubValueeID

### Sub Value Description

### Attribute Value ID

### Quantity

### Total Quantity

### Full Descriptor

### Hardware ChangeLog ID

### Hardware Package Change Log

### Product ID

### New Hardware Package ID

### Bulletin ID

### Comment

### Last Updated

### Updated By

### Attribute

### Attribute ID

### Attribute Name Product Type ID

### Order Number

### Product Attribute

### Product Attribute ID

### Product ID

### Attribute ID

### Value

### Last Updated

### Product

### Product ID

### Product Type ID

### Last Updated

### Status

### Date Created

### Product Work Flow ID

### Workflow Date ID

### Product ID

### Comment

### Value

### Last Updated

### Updated By

### Product Attribute Change Log

### Product Attribute

### Change Log ID

### Product Attribute ID

### Old Value

### New Value

### Bulletin ID

### Product ID

### Comment

### Discrepancy

### Discrepancy ID

### Comments

### Discrepancy

### Status Code

### Date Created

### Last Updated

### Updated By

### Product ID

### Bulletin

### Bulletin ID

### Name

### Description

### Product Type ID

### Product Type

### Product Type ID

### Product Type

### Name

### Product Type Desc

### Work Flow Date

### Work Flow Date ID

### Work Flow Date Name

### Work Flow Date Description

### Product Type ID

The foregoing examples have been provided merely for the purpose of explanation and are in no way to be construed as limiting of the present method and product disclosed herein. While the invention has been described with reference to various embodiments, it is understood that the words which have been used herein are words of description and illustration, rather than words of limitation. Further, although the invention has been described herein with reference to particular means, materials, and embodiments, the invention is not intended to be limited to the particulars disclosed herein; rather, the invention expands to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

What is claimed is:

1. An information system process for managing a specified construction project in real-time, comprising a server, database in communication with a computer and a remote client having a software application enabling communication between the server and client wherein the steps comprise:
a. inputting architectural drawing data and first construction information set on a server;
b. scanning construction related material data using the client and application and transmitting data to the server;
c. remotely inputting a second construction project installation information set from the specified construction project;
d. comparing the second project installation information set to architectural drawing data and the first project installation information set to ascertain construction information discrepancies and progress.

2. A software application configured for with BIM software architecture comprising: a database for storing construction specific data a first viewable portal comprising a first series of data fields a second viewable portal comprising a second series of data fields.
